(19) United States
(12) Patent Application Publication
(10) Pub. No.: US 2022/0198923 A1
(43) Pub. Date: Jun. 23, 2022

(54) METHOD, APPARATUS, AND COMPUTER PROGRAM PRODUCT FOR DETERMINING A SPLIT LANE TRAFFIC PATTERN

(71) Applicant: HERE GLOBAL B.V., Eindhoven (NL)

(72) Inventors: James Fowe, Chicago, IL (US); Arun Mohapatro, Naperville, IL (US); Earl Hammond, Chicago, IL (US); Nazia Khan, Aurora, IL (US)

(21) Appl. No.: 17/132,758

(22) Filed: Dec. 23, 2020

(51) Int. Cl. G08G 1/01

(52) U.S. Cl. CPC G08G 1/0133; G08G 1/0116

(57) ABSTRACT

A method, apparatus and computer program product are provided for determining a split lane traffic pattern for a road segment. In this regard, first traffic data for an upstream road segment of the road segment is aggregated based on a distribution of speeds associated with location probe points representative of travel of vehicles along the road segment. Furthermore, second traffic data for a first downstream road segment of the road segment is aggregated based on the distribution of speeds associated with the location probe points for the vehicles. Third traffic data for a second downstream road segment of the road segment is also aggregated based on the distribution of speeds associated with the location probe points for the vehicles. A traffic classification profile for the road segment is also determined based on statistical analysis of the first traffic data, the second traffic data and the third traffic data.

### TECHNOLOGICAL FIELD

An example embodiment of the present disclosure relates to determining a split lane traffic pattern and, more particularly, to a method, apparatus and computer program product for determining a split lane traffic pattern.

### BACKGROUND

Vehicle traffic conditions are generally different for different lanes of a road segment (e.g., a multi-lane road). For example, one or two lanes of a highway may experience a traffic jam due to a bottleneck of vehicles at an exit ramp while vehicle traffic in another lane of the highway may be traveling at a greater speed. Furthermore, traffic information related to vehicles is becoming increasingly more desirable for technologies such as advanced navigation systems, connected vehicles, autonomous vehicles, etc. However, collection of accurate traffic information for vehicles is generally challenging. Additionally, it is generally difficult to identify a location of a vehicle within a respective lane of a road segment. Rather, most vehicles are located (e.g., by a global positioning system) in such a manner that the vehicles may be matched to a respective road segment, but not to any particular lane of the road segment.

### BRIEF SUMMARY

A method, apparatus and computer program product are provided in order determine a split lane traffic pattern for a road segment. The method, apparatus and computer program product of an example embodiment are configured to determine a traffic classification profile for a road segment based on traffic data associated with an upstream road segment of the road segment, a first downstream road segment of the road segment, and/or a second downstream road segment of the road segment. Additionally, the method, apparatus and computer program product of an example embodiment are configured to employ a distribution of speeds associated with location probe points representative of travel of vehicles along the upstream road segment, the first downstream road segment, and/or the second downstream road segment to facilitate determining the traffic classification profile for the road segment. As such, precision of traffic pattern prediction for vehicles can be improved. Furthermore, improved navigation of a vehicle, improved route guidance for a vehicle, improved semi-autonomous vehicle control, and/or improved fully autonomous vehicle control can be provided.

In an example embodiment, a computer-implemented method is provided for determining a split lane traffic pattern for a road segment. The computer-implemented method includes aggregating, based on a distribution of speeds associated with location probe points representative of travel of vehicles along the road segment during an interval of time, first traffic data for an upstream road segment of the road segment. The computer-implemented method also includes aggregating, based on the distribution of speeds associated with the location probe points for the vehicles, second traffic data for a first downstream road segment of the road segment. The computer-implemented method also includes aggregating, based on the distribution of speeds associated with the location probe points for the vehicles, third traffic data for a second downstream road segment of the road segment. Furthermore, the computer-implemented method includes determining a traffic classification profile for the road segment based on statistical analysis of the first traffic data, the second traffic data and the third traffic data.

In an example embodiment, the determining the traffic classification profile comprises determining the traffic classification profile based on a first average speed associated with the first traffic data, a second average speed associated with the second traffic data, and a third average speed associated with the third traffic data. In another example embodiment, the computer-implemented method also includes partitioning the distribution of speeds associated with the upstream road segment and the first downstream road segment into respective speed clusters to facilitate determining the first average speed associated with the first traffic data and the second average speed associated with the second traffic data. In another example embodiment, the computer-implemented method also includes partitioning the distribution of speeds associated with the second downstream road segment into respective speed clusters to facilitate determining the third average speed associated with the third traffic data.

In an example embodiment, the determining the traffic classification profile comprises determining the traffic classification profile based on a first number of vehicles associated with the first traffic data, a second number of vehicles associated with the second traffic data, and a third number of vehicles associated with the third traffic data. In another example embodiment, the determining the traffic classification profile comprises determining the traffic classification profile based on a first distance interval associated with the upstream road segment, a second distance interval associated with the first downstream road segment, and a third distance interval associated with the second downstream road segment. In yet another example embodiment, the determining the traffic classification profile comprises classifying the road segment as a ramp congested event in response to a determination that a first average speed associated with the third traffic data is less than a second average speed associated with the first traffic data and the second traffic data. In yet another example embodiment, the determining the traffic classification profile comprises classifying the road segment as a highway congested event in response to a determination that a first average speed associated with the third traffic data is greater than a second average speed associated with the first traffic data and the second traffic data.

In an example embodiment, the computer-implemented method also includes facilitating routing of a vehicle based on the traffic classification profile for the road segment. In another example embodiment, the computer-implemented method also includes causing rendering of data via a map display based on the traffic classification profile for the road segment. In yet another example embodiment, the computer-implemented method also includes generating split lane congestion data based on the traffic classification profile for the road segment.

In another example embodiment, an apparatus is configured to determine a split lane traffic pattern for a road segment. The apparatus includes processing circuitry and at least one memory including computer program code instructions that are configured to, when executed by the processing circuitry, cause the apparatus to aggregate, based on a distribution of speeds associated with location probe points representative of travel of vehicles along the road segment during an interval of time, first traffic data for an upstream road segment of the road segment. The computer program code instructions are also configured to, when executed by the processing circuitry, cause the apparatus to aggregate, based on the distribution of speeds associated with the location probe points for the vehicles, second traffic data for a first downstream road segment of the road segment. The computer program code instructions are also configured to, when executed by the processing circuitry, cause the apparatus to aggregate, based on the distribution of speeds associated with the location probe points for the vehicles, third traffic data for a second downstream road segment of the road segment. The computer program code instructions are further configured to, when executed by the processing circuitry, cause the apparatus to determine a traffic classification profile for the road segment based on statistical analysis of the first traffic data, the second traffic data and the third traffic data.

The computer program code instructions are further configured to, when executed by the processing circuitry, cause the apparatus of an example embodiment to determine the traffic classification profile based on a first average speed associated with the first traffic data, a second average speed associated with the second traffic data, and a third average speed associated with the third traffic data. The computer program code instructions are further configured to, when executed by the processing circuitry, cause the apparatus of an example embodiment to determine the traffic classification profile based on a first number of vehicles associated with the first traffic data, a second number of vehicles associated with the second traffic data, and a third number of vehicles associated with the third traffic data. The computer program code instructions are further configured to, when executed by the processing circuitry, cause the apparatus of an example embodiment to determine the traffic classification profile based on a first distance interval associated with the upstream road segment, a second distance interval associated with the first downstream road segment, and a third distance interval associated with the second downstream road segment.

The computer program code instructions are further configured to, when executed by the processing circuitry, cause the apparatus of an example embodiment to classify the road segment as a ramp congested event in response to a determination that a first average speed associated with the third traffic data is less than a second average speed associated with the first traffic data and the second traffic data. The computer program code instructions are further configured to, when executed by the processing circuitry, cause the apparatus of an example embodiment to classify the road segment as a highway congested event in response to a determination that a first average speed associated with the third traffic data is greater than a second average speed associated with the first traffic data and the second traffic data.

In another example embodiment, a computer program product is provided. The computer program product includes at least one non-transitory computer readable storage medium having computer-executable program code instructions stored therein with the computer-executable program code instructions including program code instructions configured, upon execution, to aggregate, based on a distribution of speeds associated with location probe points representative of travel of vehicles along the road segment during an interval of time, first traffic data for an upstream road segment of the road segment. The computer-executable program code instructions are also configured to aggregate, based on the distribution of speeds associated with the location probe points for the vehicles, second traffic data for a first downstream road segment of the road segment. Furthermore, the computer-executable program code instructions are configured to aggregate, based on the distribution of speeds associated with the location probe points for the vehicles, third traffic data for a second downstream road segment of the road segment. The computer-executable program code instructions are also configured to determine a traffic classification profile for the road segment based on statistical analysis of the first traffic data, the second traffic data and the third traffic data.

The computer-executable program code instructions of an example embodiment are also configured to classify the road segment as a ramp congested event in response to a determination that a first average speed associated with the third traffic data is less than a second average speed associated with the first traffic data and the second traffic data. The computer-executable program code instructions of an example embodiment are also configured to classify the road segment as a highway congested event in response to a determination that a first average speed associated with the third traffic data is greater than a second average speed associated with the first traffic data and the second traffic data.

In another example embodiment, an apparatus is provided that includes means for aggregating, based on a distribution of speeds associated with location probe points representative of travel of vehicles along the road segment during an interval of time, first traffic data for an upstream road segment of the road segment. The apparatus of this example embodiment also includes means for aggregating, based on the distribution of speeds associated with the location probe points for the vehicles, second traffic data for a first downstream road segment of the road segment. The apparatus of this example embodiment also includes means for aggregating, based on the distribution of speeds associated with the location probe points for the vehicles, third traffic data for a second downstream road segment of the road segment. Furthermore, the apparatus of this example embodiment includes means for determining a traffic classification profile for the road segment based on statistical analysis of the first traffic data, the second traffic data and the third traffic data.

The means for determining the determining the traffic classification profile in an example embodiment comprises means for determining the traffic classification profile based on a first average speed associated with the first traffic data, a second average speed associated with the second traffic data, and a third average speed associated with the third traffic data.

The apparatus of another example embodiment also includes means for partitioning the distribution of speeds associated with the upstream road segment and the first downstream road segment into respective speed clusters to facilitate determining the first average speed associated with the first traffic data and the second average speed associated with the second traffic data. The apparatus of another example embodiment also includes means for partitioning the distribution of speeds associated with the second downstream road segment into respective speed clusters to facilitate determining the third average speed associated with the third traffic data.

The means for determining the determining the traffic classification profile in an example embodiment comprises means for determining the traffic classification profile based on a first number of vehicles associated with the first traffic data, a second number of vehicles associated with the second traffic data, and a third number of vehicles associated with the third traffic data. The means for determining the determining the traffic classification profile in an example embodiment comprises means for determining the traffic classification profile based on a first distance interval associated with the upstream road segment, a second distance interval associated with the first downstream road segment, and a third distance interval associated with the second downstream road segment.

The means for determining the determining the traffic classification profile in an example embodiment comprises means for classifying the road segment as a ramp congested event in response to a determination that a first average speed associated with the third traffic data is less than a second average speed associated with the first traffic data and the second traffic data. The means for determining the determining the traffic classification profile in an example embodiment comprises means for classifying the road segment as a highway congested event in response to a determination that a first average speed associated with the third traffic data is greater than a second average speed associated with the first traffic data and the second traffic data.

The apparatus of another example embodiment also includes means for facilitating routing of a vehicle based on the traffic classification profile for the road segment. The apparatus of another example embodiment also includes means for causing rendering of data via a map display based on the traffic classification profile for the road segment. The apparatus of another example embodiment also includes means for generating split lane congestion data based on the traffic classification profile for the road segment.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus for determining a split lane traffic pattern in accordance with one or more example embodiments of the present disclosure;

FIG. 2 is a flowchart illustrating operations performed, such as by the apparatus of FIG. 1, in order to determine a split lane traffic pattern for a road segment in accordance with one or more example embodiments of the present disclosure;

FIG. 3 illustrates a road segment that includes an upstream road segment as well as a pair of downstream road segments that are evaluated in accordance with one or more example embodiments of the present disclosure;

FIG. 4 is a block diagram of a system for determining a split lane traffic pattern for a road segment in accordance with one or more example embodiments of the present disclosure;

FIG. 5 illustrates traffic classification profile data for a road segment in accordance with one or more example embodiments of the present disclosure;

FIG. 6 illustrates a graphical representation of a manner in which a distribution of speeds is evaluated in accordance with one or more example embodiments of the present disclosure;

FIG. 7 illustrates a road segment in accordance with one or more example embodiments of the present disclosure;

FIG. 8 illustrates another road segment in accordance with one or more example embodiments of the present disclosure; and

FIG. 9 is an example embodiment of an architecture configured for implementing one or more embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

A method, apparatus and computer program product are provided in accordance with an example embodiment in order to determine a split lane traffic pattern for a road segment. In an embodiment, split lane traffic information can be determined to provide lane level precision on a road segment (e.g., road, highway, and/or ramp) where a discrepancy in speeds is determined between lanes prior to a divergence in the road segment. In one example, the divergence in the road segment can be an intersection between a highway and a ramp (e.g., an exit ramp) associated with the highway. In another example, the divergence in the road segment can be a highway split where a highway splits into two highways. In yet another example, the divergence in the road segment can be a scenario where a highway ramp leads to a major backup on the highway and the non-ramp lanes do not lead to the major backup (or vice versa). In an aspect, the split lane traffic information can facilitate prediction of lane-level traffic for a future interval of time associated with a road segment can be provided. In another aspect, the split lane traffic information can facilitate determination of an optimal route (e.g., a safest route and/or a fastest route) related to lane-level navigation and/or guidance.

In another embodiment, one or more historical traffic patterns of one or more split lane traffic events can be generated. The one or more historical traffic patterns can include data associated with a frequency of vehicles traveling along a portion of a road segment (e.g., a highway and/or a ramp), a number of vehicles traveling along the portion of the road segment, an average speed of vehicle traffic traveling along the portion of the road segment, an average propagation length on the portion of the road segment, and/or other statistical information associated with the portion of the road segment at various intervals of time (e.g., at various 5 minute epochs, at various 15 minute epochs, at various weekly epochs, etc.). In certain embodiments, statistical data associated with a road segment (e.g., a highway and/or a ramp) can be obtained via one or more clustering algorithms. For example, an average speed on a highway and a ramp can be obtained via one or more clustering algorithms. In certain embodiments, a historical probe archive can be employed to determine one or more split lane traffic events for one or more split lane traffic topologies. In certain embodiments, a split lane traffic pattern can be generated using historical global positioning system (GPS) probe data. Furthermore, the split lane traffic pattern can be matched to one or more portions of a high-definition map associated with one or more road segments.

In certain embodiments, similar split lane traffic events can be aggregated such that opposite split lane traffic events (e.g., a first split lane traffic event associated with congestion on highway and free-flow on ramp versus a second split lane traffic event associated with congestion on ramp and free-flow on highway) are not averaged out when aggregated over a certain interval of time (e.g., one to two years of historical data). In certain embodiments, one or more split lane traffic profiles can be generated for split lane traffic events. In an aspect, aggregated split lane traffic events can form a split lane traffic profile. In another aspect, various split lane traffic events can be classified into different split lane traffic profiles. In certain embodiments, an average historical speed can be determined for respective split lane traffic profiles to facilitate classification of split lane traffic events.

In an exemplary embodiment, a split lane traffic event can be profiled as a first classification or a second classification. For example, the first classification can be associated with a highway congested event (e.g., where a highway is more congested than a ramp) and the second classification can be associated with a ramp congested event (e.g., where a ramp is more congested than a highway). In another exemplary embodiment, a split lane traffic event can be profiled as a first classification, a second classification or a third classification. For example, the first classification can be associated with a free-flow traffic event (e.g., a green traffic event), the second classification can be associated with a light congestion traffic event (e.g., a yellow traffic event), and the third classification can be associated with a heavy congestion traffic event (e.g., a red traffic event).

In certain embodiments, various permutations of classifications between a highway portion of a road segment and a ramp portion of a road segment can be provided. For example, a first split lane traffic profile can correspond to a Yellow-Highway traffic event and a Red-Ramp traffic event, a second split lane traffic profile can correspond to Yellow-Highway traffic event and Green-Ramp traffic event, a third split lane traffic profile can correspond to Green-Highway traffic event and Yellow-Ramp traffic event, a fourth split lane traffic profile can correspond to Red-Highway traffic event and Yellow-Ramp traffic event, a fifth split lane traffic profile can correspond to Yellow-Highway traffic event and Yellow-Ramp traffic event, and a sixth split lane traffic profile can correspond to Green-Highway traffic event and Red-Ramp traffic event.

In certain embodiments, the one or more historical traffic patterns can be published as a content product. Additionally or alternatively, the one or more historical traffic patterns can be employed to improve a real-time predictive traffic product. In one example, the content product (e.g., the real-time predictive traffic product) can capture and/or provide historical lane-level traffic differentiation with respect to highway ramps. In certain embodiments, one or more traffic patterns of one or more split lane traffic events can be rendered, via an electronic interface, as one or more visual indicators overlaid on one or more graphical elements associated with a highway. In certain embodiments, one or more traffic patterns of one or more split lane traffic events can be provided as input to a predictive machine learning model to estimate traffic on road segment intersections (e.g., highway ramp splits). In certain embodiments, after a traffic jam being experienced by and/or caused by an intersection is identified, drivers experiencing the traffic jam may be alerted, expected travel and/or arrival times may be updated, traffic management apparatuses may be notified, and/or the like. Furthermore, if it is determined that a particular intersection of a road segment is prone to experiencing and/or causing traffic jams, the particular intersection may be flagged for review and/or remediation.

Accordingly, improved traffic pattern prediction for vehicles can be provided. Computational resources for improved traffic pattern prediction for vehicles can also be conserved. The traffic pattern prediction may additionally facilitate improved navigation of a vehicle, improved route guidance for a vehicle, improved semi-autonomous vehicle control, and/or improved fully autonomous vehicle control. For example, autonomous driving has become a focus of recent technology with recent advances in machine learning, computer vision, and computing power able to conduct real-time mapping and sensing of a vehicle's environment. Such an understanding of the environment enables autonomous driving in two distinct ways. Primarily, real-time or near real-time sensing of the environment can provide information about potential obstacles, the behavior of others on the roadway, and areas that are navigable by the vehicle. An understanding of the location of other vehicles and/or what the other vehicles have done and may be predicted to do may be useful for a vehicle to safely plan a route. However, redundant mechanisms are of importance to ensure reliable operation of vehicles in environments to compensate for when one sensor or array of sensors is compromised. As such, embodiments described herein employ sensors to collect location probe points to identify a location of vehicles along a road segment which can provide vehicle localization and/or can facilitate determining a split lane traffic pattern for the road segment to enhance location data and/or traffic pattern prediction for vehicles.

Accurate traffic pattern prediction for vehicles is also useful for autonomous vehicle control. Such traffic pattern prediction enables the understanding of a position and heading with respect to a roadway. This information is useful for planning an efficient and safe route as driving involves complex situations and maneuvers which need to be executed in a timely fashion, and often before they are visually obvious. Traffic pattern prediction also enables the incorporation of other real-time information into route planning for vehicles. Such information can include traffic predictions, areas with congested and/or unsafe driving conditions, temporary road changes, etc.

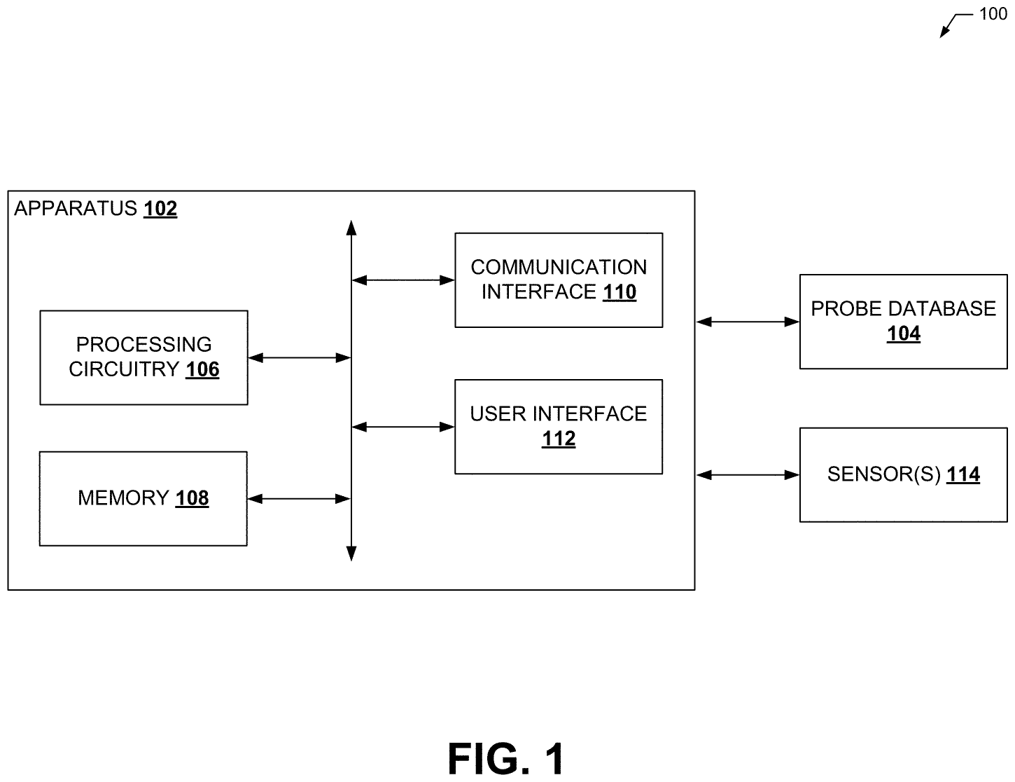

With reference to FIG. 1, a system 100 configured to determine one or more split lane traffic patterns for one or more road segment is depicted, in accordance with one or more embodiments of the present disclosure. In the illustrated embodiment, the system 100 includes an apparatus 102 and a probe database 104. As described further below, the apparatus 102 is configured in accordance with an example embodiment of the present disclosure to assist localization of a vehicle and/or to provide for vehicle localization with respect to a lane of a road segment. The apparatus 102 can be embodied by any of a wide variety of computing devices including, for example, a computer system of a vehicle, a vehicle system of a vehicle, a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) module of a vehicle, or any other type of computing device carried by or remote from the vehicle including, for example, a server or a distributed network of computing devices.

In an example embodiment where some level of vehicle autonomy is involved, the apparatus 102 can be embodied or partially embodied by a computing device of a vehicle that supports safety-critical systems such as the powertrain (engine, transmission, electric drive motors, etc.), steering (e.g., steering assist or steer-by-wire), and/or braking (e.g., brake assist or brake-by-wire). However, as certain embodiments described herein may optionally be used for map generation, map updating, and map accuracy confirmation, other embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 100 to carry out various functions in accordance with an example embodiment of the present disclosure. For example, the memory 108 can be configured to buffer input data (e.g., probe data, location probe points, etc.) for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the probe database 104 that stores data (e.g., probe data, GPS probe data, location probe point data, vehicle speed data, statistical data, time data, location data, geo-referenced locations, etc.) generated and/or employed by the processing circuitry 106. Additionally or alternatively, the communication interface 110 can be configured to communicate in accordance with various wireless protocols including Global System for Mobile Communications (GSM), such as but not limited to Long Term Evolution (LTE). In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

In certain embodiments, the apparatus 102 can also optionally include or otherwise be in communication with a user interface 112. The user interface 112 can include a display, a touch screen display, a keyboard, a mouse, a joystick, speakers or other input/output mechanisms. In some embodiments, the processing circuitry 106 can comprise user interface circuitry configured to control at least some functions of one or more input/output mechanisms of the user interface 112. The processing circuitry 106 can be configured to control one or more functions of one or more input/output mechanisms of the user interface 112 through computer program instructions (e.g., software and/or firmware) stored on a memory (e.g., the memory 108 and/or the like) accessible to the processing circuitry 106.

In certain embodiments, the apparatus 102 can be in communication with one or more sensors 114, such as one or more GPS sensors, one or more accelerometer sensors, one or more LiDAR sensors, one or more radar sensors, one or more gyroscope sensors, and/or one or more other sensors. Any of the one or more sensors 114 may be used to sense information regarding movement, positioning, and/or orientation of a vehicle for use in navigation assistance and/or autonomous vehicle control, as described herein according to example embodiments. In certain embodiments, sensor data transmitted by the one or more sensors 114 can be transmitted via one or more wired communications and/or one or more wireless communications (e.g., near field communication, or the like). In some environments, the communication interface 110 can support wired communication and/or wireless communication with the one or more sensors 114.

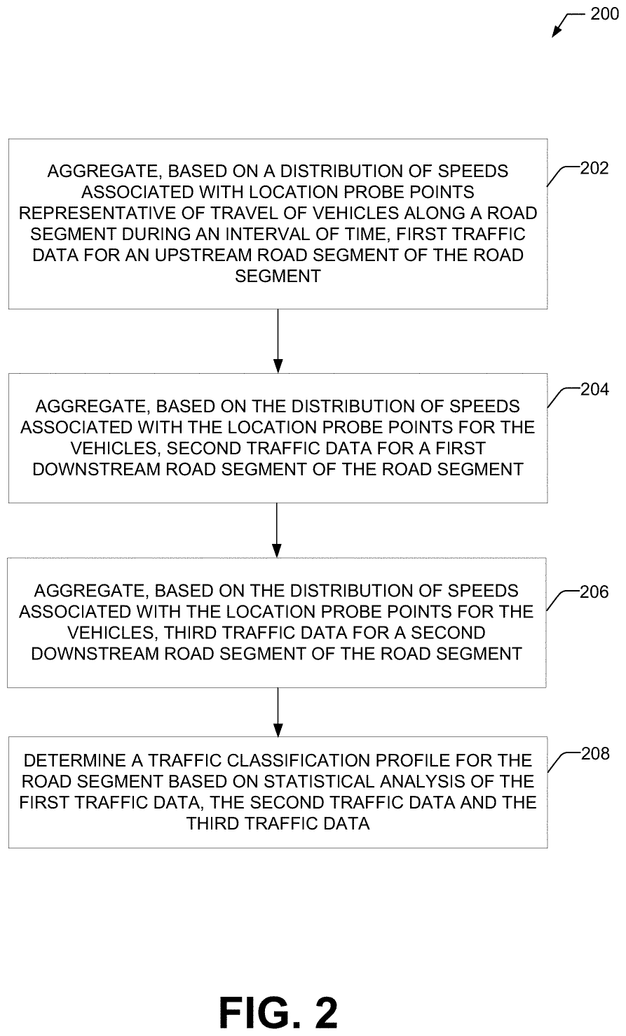

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 2, the operations performed, such as by the apparatus 102 of FIG. 1, in order to provide for determining a split lane traffic pattern for a road segment are depicted, in accordance with one or more embodiments of the present disclosure. As shown in block 202 of FIG. 2, the apparatus 102 includes means, such as the processing circuitry 106, the memory 108, or the like, configured to aggregate, based on a distribution of speeds associated with location probe points representative of travel of vehicles along a road segment during an interval of time, first traffic data for an upstream road segment of the road segment.

The road segment can be, for example, a roadway (e.g., a multi-lane roadway) that comprises two or more lanes and/or one or more ramps. For example, the multi-lane roadway can be a highway associated with one or more exit ramps. The upstream road segment can be, for example, a first highway lane of the road segment. In an embodiment, the upstream road segment can form a portion of an intersection associated with the road segment. For example, the upstream road segment can be a first highway lane that intersects with a second highway lane of the road segment and a ramp of the road segment.

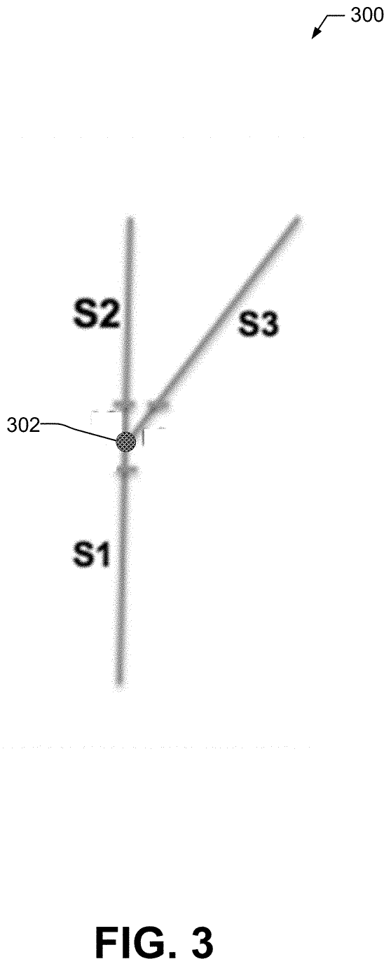

An example of the road segment is depicted in FIG. 3. As shown in FIG. 3, a road segment 300 includes an upstream road segment S1, a first downstream road segment S2 and a second downstream road segment S3. In an aspect, the upstream road segment S1, the first downstream road segment S2 and the second downstream road segment S3 can intersect at an intersection 302. For instance, the upstream road segment S1 can intersect with the first downstream road segment S2 and the second downstream road segment S3 at the intersection 302. As such, the intersection 302 can be, for example, split lane traffic location associated with the upstream road segment S1, the first downstream road segment S2 and the second downstream road segment S3. The upstream road segment S1 can include, for example, two or more lanes of traffic. In an embodiment, the upstream road segment S1 can be upstream of two diverging downstream road segments, namely, the first downstream road segment S2 which is a continuation of the upstream road segment S1 and the second downstream road segment S3 that can correspond to a ramp (e.g., an exit ramp). In this example, a right lane of the upstream road segment S1 may be more greatly impacted by traffic slowing to take the ramp represented by the second downstream road segment S3 in comparison to a left lane of the upstream road segment S1 which continues along the first downstream road segment S2.

The location probe points associated with the upstream road segment of the road segment can be historical probe points associated with locations of the vehicles traveling along the upstream road segment of the road segment during the interval of time. As such, the location probe points associated with the upstream road segment of the road segment can be representative of travel of the vehicles along the upstream road segment of the road segment. In an embodiment, the location probe points associated with the upstream road segment of the road segment can be data included in the probe data. At least a portion of the location probe points associated with the upstream road segment of the road segment can be stored remotely by cloud storage, a remote server, a remote database or the like accessible by the processing circuitry 106. For instance, in an embodiment, the location probe points can be stored in the probe database 104. Additionally or alternatively, at least a portion of the location probe points associated with the upstream road segment of the road segment can be stored locally by a memory (e.g., the memory 108) or the like accessible by the processing circuitry 106.

In certain embodiments, the location probe points associated with the upstream road segment of the road segment can be captured via the one or more sensors 114. For example, the location probe points associated with the upstream road segment of the road segment can be captured via one or more GPS sensors associated with the vehicles traveling along the upstream road segment of the road segment during the interval of time. In certain embodiments, the location probe points associated with the upstream road segment of the road segment can be captured via respective navigation systems and/or respective location tracking systems associated with the vehicles. The one or more sensors 114 can be carried by the vehicles, for example, as the vehicles travel along the upstream road segment of the road segment.

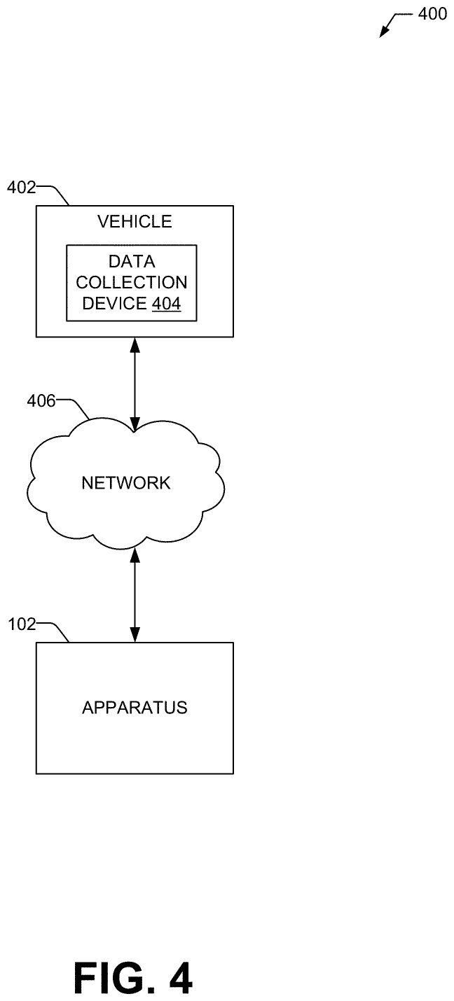

An example of a vehicle that generates at least a portion of the location probe points associated with the upstream road segment of the road segment is depicted in FIG. 4. As shown in FIG. 4, a vehicle 400 includes a data collection device 404. The data collection device 404 can be configured to capture one or more location probe points as the vehicle 402 travels along a road segment (e.g., the upstream road segment of the road segment). In an embodiment, the data collection device 404 can include one or more sensors from the one or more sensors 114. In an embodiment, the location probe points associated with the upstream road segment can include geographic coordinates for respective vehicle. In an embodiment, the location probe points associated with the upstream road segment can include latitude data and/or longitude data defining the location of the vehicle. For example, in an embodiment, the apparatus 102, such as the processing circuitry 106, can receive the location probe points associated with the upstream road segment from a GPS or other location sensor of the vehicle. In another embodiment, the apparatus 102, such as the processing circuitry 106, can receive the location probe points associated with the upstream road segment from a LiDAR sensor of the vehicle. In yet another embodiment, the apparatus 102, such as the processing circuitry 106, can receive the location probe points associated with the upstream road segment from one or more ultrasonic sensors and/or one or more infrared sensors of the vehicle.

The data collection device 404 can be mounted, in an embodiment, within the vehicle 402, such as a component of a navigation system, an ADAS or the like. Alternatively, the data collection device 404 can be carried by a passenger within the vehicle 402, such as in an instance in which the data collection device 404 is embodied by mobile device, a smartphone, a tablet computer, a wearable device, a virtual reality device or another portable computing device carried by the passenger riding within the vehicle 402. In an aspect, the data collection device 404 can repeatedly capture at least a portion of the location probe points associated with the upstream road segment of the road segment as the data collection device 404 moves along the upstream road segment of the road segment. For example, the data collection device 404 can capture at least a portion of the location probe points associated with the upstream road segment of the road segment at a defined frequency.

Each location probe point from the location probe points associated with the upstream road segment of the road segment defines a location at which the location probe point was captured. In an aspect, each location probe point from the location probe points can represent the location in terms of latitude and longitude associated with the upstream road segment of the road segment. Additionally or alternatively, each location probe point from the location probe points associated with the upstream road segment of the road segment can be map matched so as to be associated with a respective road segment (e.g., the upstream road segment of the road segment). Each location probe point from the location probe points associated with the upstream road segment of the road segment can additionally be associated with a variety of other information including, for example, a speed of the vehicle 402 associated with capture of the location probe point, a time at which the location probe point was captured, an epoch at which the location probe point was captured, a direction of travel of the vehicle 402 associated with capture of the location probe point, a vehicle type associated with the vehicle 402, a road condition associated with the upstream road segment of the road segment during the capture of the location probe point, an environmental condition associated with the upstream road segment of the road segment during the capture of the location probe point, other information associated with the vehicle 402, other information associated with capture of the location probe point, etc.

In an embodiment, the data collection device 404 can capture at least a portion of the location probe points during the interval of time associated with the travel of the vehicles along the upstream road segment of the road segment. The interval of time can be, for example, an interval of time associated with a certain number of minutes, a certain number of days, a certain number of weeks, a certain number of months and/or a certain number of years.

The apparatus 102, such as the processing circuitry 106, can also be configured to aggregate the location probe points associated with the upstream road segment of the road segment (e.g., the location probe points provided by the vehicle 402 and/or one or more other vehicles configured with a data collection device). For example, the apparatus 102, such as the processing circuitry 106 and/or the communication interface 110, can be configured to communicate with the vehicle 402 and/or one or more other vehicles via a network 406. The network 406 can be one or more wireless networks and/or one or more wired networks such as, for example, a wired or wireless Personal Area Network (PAN), Local Area Network (LAN), Metropolitan Area Network (MAN), Wide Area Network (WAN), cellular network, and/or the like. In some embodiments, the network 406 can include an automotive cloud, a digital transportation infrastructure (DTI), a radio data system (RDS), a high definition (HD) radio, another digital radio system, and/or the like.

In an embodiment, the apparatus 102, such as the processing circuitry 106, can be configured to aggregate and/or categorize the location probe points associated with the upstream road segment of the road segment. For instance, the apparatus 102, such as the processing circuitry 106, can be configured to aggregate and/or categorize the location probe points captured during the interval of time based on vehicle speed and/or epoch associated with the location probe points. In certain embodiments, the apparatus 102, such as the processing circuitry 106, can be configured to aggregate and/or categorize the location probe points associated with the upstream road segment of the road segment into a plurality of epochs. Each epoch may be of the same duration, such as 5 minutes. Each location probe point may therefore be associated with a respective epoch during which the location probe point was captured. In another embodiment, the apparatus 102, such as the processing circuitry 106, can be configured to aggregate and/or categorize the location probe points associated with the upstream road segment of the road segment to form the first traffic data. For example, the first traffic data can include respective speeds of the vehicles traveling along the upstream road segment of the road segment during the interval of time, a number of the vehicles traveling along the upstream road segment of the road segment during the interval of time, and/or a distance interval associated with the upstream road segment.

As shown in block 204 of FIG. 2, the apparatus 102 includes means, such as the processing circuitry 106, the memory 108, or the like, configured to aggregate, based on the distribution of speeds associated with the location probe points for the vehicles, second traffic data for a first downstream road segment of the road segment. The first downstream road segment can be, for example, a second highway lane of the road segment. In an embodiment, the first downstream road segment can form another portion of the intersection associated with the road segment. For example, the first downstream road segment can be a second highway lane that intersects with the upstream road segment and a ramp of the road segment.

Referring back to FIG. 3, the first downstream road segment can correspond to the first downstream road segment S2 of the road segment 300. The first downstream road segment S2 can intersect with the upstream road segment S1 and the second downstream road segment S3 at the intersection 302. In an aspect, the first downstream road segment S2 can include, for example, two or more lanes of traffic. Furthermore, the first downstream road segment S2 can be a continuation of the upstream road segment S1 after the intersection 302. For instance, the first downstream road segment S2 can be downstream of the upstream road segment S1.

The location probe points associated with the first downstream road segment of the road segment can be historical probe points associated with locations of the vehicles traveling along the first downstream road segment of the road segment during the interval of time. As such, the location probe points associated with the first downstream road segment of the road segment can be representative of travel of the vehicles along the first downstream road segment of the road segment. In an embodiment, the location probe points associated with the first downstream road segment of the road segment can be data included in the probe data. At least a portion of the location probe points associated with the first downstream road segment of the road segment can be stored remotely by cloud storage, a remote server, a remote database or the like accessible by the processing circuitry 106. For instance, in an embodiment, the location probe points associated with the first downstream road segment of the road segment can be stored in the probe database 104. Additionally or alternatively, at least a portion of the location probe points associated with the first downstream road segment of the road segment can be stored locally by a memory (e.g., the memory 108) or the like accessible by the processing circuitry 106.

In certain embodiments, the location probe points associated with the first downstream road segment of the road segment can be captured via the one or more sensors 114. For example, the location probe points associated with the first downstream road segment of the road segment can be captured via one or more GPS sensors associated with the vehicles traveling along the first downstream road segment of the road segment during the interval of time. In certain embodiments, the location probe points associated with the first downstream road segment of the road segment can be captured via respective navigation systems and/or respective location tracking systems associated with the vehicles. The one or more sensors 114 can be carried by the vehicles, for example, as the vehicles travel along the first downstream road segment of the road segment.

An example of a vehicle that generates at least a portion of the location probe points associated with the first downstream road segment of the road segment is depicted in FIG. 4. As discussed above, the vehicle 400 includes the data collection device 404. The data collection device 404 can be configured to capture one or more location probe points associated with the first downstream road segment of the road segment as the vehicle 402 travels along a road segment (e.g., the first downstream road segment of the road segment). In an embodiment, the location probe points associated with the first downstream road segment can include geographic coordinates for respective vehicle. In an embodiment, the location probe points associated with the first downstream road segment can include latitude data and/or longitude data defining the location of the vehicle. For example, in an embodiment, the apparatus 102, such as the processing circuitry 106, can receive the location probe points associated with the first downstream road segment from a GPS or other location sensor of the vehicle. In another embodiment, the apparatus 102, such as the processing circuitry 106, can receive the location probe points associated with the first downstream road segment from a LiDAR sensor of the vehicle. In yet another embodiment, the apparatus 102, such as the processing circuitry 106, can receive the location probe points associated with the first downstream road segment from one or more ultrasonic sensors and/or one or more infrared sensors of the vehicle.

In an aspect, the data collection device 404 can repeatedly capture at least a portion of the location probe points associated with the first downstream road segment of the road segment as the data collection device 404 moves along the first downstream road segment of the road segment. For example, the data collection device 404 can capture at least a portion of the location probe points associated with the first downstream road segment of the road segment at a defined frequency. Each location probe point from the location probe points associated with the first downstream road segment of the road segment defines a location at which the location probe point was captured.

In an aspect, each location probe point from the location probe points can represent the location in terms of latitude and longitude associated with the first downstream road segment of the road segment. Additionally or alternatively, each location probe point from the location probe points can be map matched so as to be associated with a respective road segment (e.g., the first downstream road segment of the road segment). Each location probe point from the location probe points can additionally be associated with a variety of other information including, for example, a speed of the vehicle 402 associated with capture of the location probe point, a time at which the location probe point was captured, an epoch at which the location probe point was captured, a direction of travel of the vehicle 402 associated with capture of the location probe point, a vehicle type associated with the vehicle 402, a road condition associated with the first downstream road segment of the road segment during the capture of the location probe point, an environmental condition associated with the first downstream road segment of the road segment during the capture of the location probe point, other information associated with the vehicle 402, other information associated with capture of the location probe point, etc. In an embodiment, the data collection device 404 can capture at least a portion of the location probe points associated with the first downstream road segment of the road segment during the interval of time associated with the travel of the vehicles along the first downstream road segment of the road segment. The interval of time can be, for example, an interval of time associated with a certain number of minutes, a certain number of days, a certain number of weeks, a certain number of months and/or a certain number of years.

The apparatus 102, such as the processing circuitry 106, can also be configured to aggregate the location probe points associated with the first downstream road segment of the road segment (e.g., the location probe points provided by the vehicle 402 and/or one or more other vehicles configured with a data collection device). For example, the apparatus 102, such as the processing circuitry 106 and/or the communication interface 110, can be configured to communicate with the vehicle 402 and/or one or more other vehicles via the network 406. In an embodiment, the apparatus 102, such as the processing circuitry 106, can be configured to aggregate and/or categorize the location probe points associated with the first downstream road segment of the road segment. For instance, the apparatus 102, such as the processing circuitry 106, can be configured to aggregate and/or categorize the location probe points captured during the interval of time based on vehicle speed and/or epoch associated with the location probe points.

In certain embodiments, the apparatus 102, such as the processing circuitry 106, can be configured to aggregate and/or categorize the location probe points associated with the first downstream road segment of the road segment into a plurality of epochs. Each epoch may be of the same duration, such as 5 minutes. Each location probe point may therefore be associated with a respective epoch during which the location probe point was captured. In another embodiment, the apparatus 102, such as the processing circuitry 106, can be configured to aggregate and/or categorize the location probe points associated with the first downstream road segment of the road segment to form the second traffic data. For example, the second traffic data can include respective speeds of the vehicles traveling along the first downstream road segment of the road segment during the interval of time, a number of the vehicles traveling along the first downstream road segment of the road segment during the interval of time, and/or a distance interval associated with the first downstream road segment.

As shown in block 206 of FIG. 2, the apparatus 102 includes means, such as the processing circuitry 106, the memory 108, or the like, configured to aggregate, based on the distribution of speeds associated with the location probe points for the vehicles, third traffic data for a second downstream road segment of the road segment. The second downstream road segment can be, for example, a ramp (e.g., an exit ramp) of the road segment. In an embodiment, the second downstream road segment can form another portion of the intersection associated with the road segment. For example, the second downstream road segment can be a ramp that intersects with the upstream road segment and the first downstream road segment of the road segment.

Referring back to FIG. 3, the second downstream road segment can correspond to the second downstream road segment S3 of the road segment 300. The second downstream road segment S3 can intersect with the upstream road segment S1 and the first downstream road segment S2 at the intersection 302. In an aspect, the second downstream road segment S2 can be, for example, a ramp (e.g., an exit ramp) accessible via the upstream road segment S1. For example, the second downstream road segment S2 can be, for example, a ramp (e.g., an exit ramp) accessible via a right lane of the upstream road segment S1. Furthermore, the second downstream road segment S2 can be downstream of the upstream road segment S1.

The location probe points associated with the second downstream road segment of the road segment can be historical probe points associated with locations of the vehicles traveling along the second downstream road segment of the road segment during the interval of time. As such, the location probe points associated with the second downstream road segment of the road segment can be representative of travel of the vehicles along the second downstream road segment of the road segment. In an embodiment, the location probe points associated with the second downstream road segment of the road segment can be data included in the probe data. At least a portion of the location probe points associated with the second downstream road segment of the road segment can be stored remotely by cloud storage, a remote server, a remote database or the like accessible by the processing circuitry 106. For instance, in an embodiment, the location probe points associated with the second downstream road segment of the road segment can be stored in the probe database 104. Additionally or alternatively, at least a portion of the location probe points associated with the second downstream road segment of the road segment can be stored locally by a memory (e.g., the memory 108) or the like accessible by the processing circuitry 106.

In certain embodiments, the location probe points associated with the second downstream road segment of the road segment can be captured via the one or more sensors 114. For example, the location probe points associated with the second downstream road segment of the road segment can be captured via one or more GPS sensors associated with the vehicles traveling along the second downstream road segment of the road segment during the interval of time. In certain embodiments, the location probe points associated with the second downstream road segment of the road segment can be captured via respective navigation systems and/or respective location tracking systems associated with the vehicles. The one or more sensors 114 can be carried by the vehicles, for example, as the vehicles travel along the second downstream road segment of the road segment.

An example of a vehicle that generates at least a portion of the location probe points associated with the second downstream road segment of the road segment is depicted in FIG. 4. As discussed above, the vehicle 400 includes the data collection device 404. The data collection device 404 can be configured to capture one or more location probe points associated with the second downstream road segment of the road segment as the vehicle 402 travels along a road segment (e.g., the second downstream road segment of the road segment). In an embodiment, the location probe points associated with the second downstream road segment can include geographic coordinates for respective vehicle.

In an embodiment, the location probe points associated with the second downstream road segment can include latitude data and/or longitude data defining the location of the vehicle. For example, in an embodiment, the apparatus 102, such as the processing circuitry 106, can receive the location probe points associated with the second downstream road segment from a GPS or other location sensor of the vehicle. In another embodiment, the apparatus 102, such as the processing circuitry 106, can receive the location probe points associated with the second downstream road segment from a LiDAR sensor of the vehicle. In yet another embodiment, the apparatus 102, such as the processing circuitry 106, can receive the location probe points associated with the second downstream road segment from one or more ultrasonic sensors and/or one or more infrared sensors of the vehicle.

In an aspect, the data collection device 404 can repeatedly capture at least a portion of the location probe points associated with the second downstream road segment of the road segment as the data collection device 404 moves along the second downstream road segment of the road segment. For example, the data collection device 404 can capture at least a portion of the location probe points associated with the second downstream road segment of the road segment at a defined frequency. Each location probe point from the location probe points associated with the second downstream road segment of the road segment defines a location at which the location probe point was captured.

In an aspect, each location probe point from the location probe points can represent the location in terms of latitude and longitude associated with the second downstream road segment of the road segment. Additionally or alternatively, each location probe point from the location probe points can be map matched so as to be associated with a respective road segment (e.g., the second downstream road segment of the road segment). Each location probe point from the location probe points can additionally be associated with a variety of other information including, for example, a speed of the vehicle 402 associated with capture of the location probe point, a time at which the location probe point was captured, an epoch at which the location probe point was captured, a direction of travel of the vehicle 402 associated with capture of the location probe point, a vehicle type associated with the vehicle 402, a road condition associated with the second downstream road segment of the road segment during the capture of the location probe point, an environmental condition associated with the second downstream road segment of the road segment during the capture of the location probe point, other information associated with the vehicle 402, other information associated with capture of the location probe point, etc.

In an embodiment, the data collection device 404 can capture at least a portion of the location probe points associated with the second downstream road segment of the road segment during the interval of time associated with the travel of the vehicles along the second downstream road segment of the road segment. The interval of time can be, for example, an interval of time associated with a certain number of minutes, a certain number of days, a certain number of weeks, a certain number of months and/or a certain number of years.

The apparatus 102, such as the processing circuitry 106, can also be configured to aggregate the location probe points associated with the second downstream road segment of the road segment (e.g., the location probe points provided by the vehicle 402 and/or one or more other vehicles configured with a data collection device). For example, the apparatus 102, such as the processing circuitry 106 and/or the communication interface 110, can be configured to communicate with the vehicle 402 and/or one or more other vehicles via the network 406. In an embodiment, the apparatus 102, such as the processing circuitry 106, can be configured to aggregate and/or categorize the location probe points associated with the second downstream road segment of the road segment. For instance, the apparatus 102, such as the processing circuitry 106, can be configured to aggregate and/or categorize the location probe points captured during the interval of time based on vehicle speed and/or epoch associated with the location probe points.

In certain embodiments, the apparatus 102, such as the processing circuitry 106, can be configured to aggregate and/or categorize the location probe points associated with the second downstream road segment of the road segment into a plurality of epochs. Each epoch may be of the same duration, such as 5 minutes. Each location probe point may therefore be associated with a respective epoch during which the location probe point was captured. In another embodiment, the apparatus 102, such as the processing circuitry 106, can be configured to aggregate and/or categorize the location probe points associated with the second downstream road segment of the road segment to form the third traffic data. For example, the third traffic data can include respective speeds of the vehicles traveling along the second downstream road segment of the road segment during the interval of time, a number of the vehicles traveling along the second downstream road segment of the road segment during the interval of time, and/or a distance interval associated with the second downstream road interval.

It is to be appreciated that the road segment 300 may have various topologies and, as such, may diverge from the upstream road segment S1, first downstream road segment S2, and the second downstream road segment S3 topology shown in FIG. 3. For instance, the first downstream road segment S2 and the second downstream road segment S3 with respect to the upstream road segment S1 can have various topologies and, as such, the first downstream road segment S2 and the second downstream road segment S3 may diverge from the upstream road segment S1 in various manners. For example, the second downstream road segment S3 may diverge either to the right or the left with other lanes of traffic proceeding onward past the second downstream road segment S3. Alternatively, the first downstream road segment S2 and the second downstream road segment S3 may represent a fork or a “Y” in which the upstream road segment S1 splits into two different diverging downstream road segments (e.g., the first downstream road segment S2 and the second downstream road segment S3), neither of which serves as an exit ramp. Regardless of the type of diverging downstream road segments formed by the first downstream road segment S2 and the second downstream road segment S3, the first downstream road segment S2 and the second downstream road segment S3 may be identified, either concurrent with or in advance of the identification of the intersection 302.

Moreover, it is to be appreciated that the first downstream road segment S2 and the second downstream road segment S3 may be identified in various manners. For example, the first downstream road segment S2 and the second downstream road segment S3 may have been previously identified, such as manually during the design of a map or by a prior computerized analysis of the map. Furthermore, the first downstream road segment S2 and the second downstream road segment S3 may be stored, such as either locally by memory 108 or remotely by a memory with which the apparatus 102 is in communication, such as via the communication interface 110. Alternatively the apparatus 102, such as the processing circuitry 106, can be configured to evaluate a network of roads, such as represented by map data, and to identify the locations at which a road, such as a multi-lane road, diverges into the first downstream road segment S2 and the second downstream road segment S3.

As shown in block 208 of FIG. 2, the apparatus 102 includes means, such as the processing circuitry 106, the memory 108, or the like, configured to determine a traffic classification profile for the road segment based on statistical analysis of the first traffic data, the second traffic data and the third traffic data. The traffic classification profile for the road segment can be, for example, a classification profile for the first traffic data, the second traffic data and/or the third traffic data. In an embodiment, the traffic classification profile for the road segment can be determined based on an average speed associated with the first traffic data, the second traffic data and/or the third traffic data. For instance, the apparatus 102, such as the processing circuitry 106, can be configured to determine the traffic classification profile based on a first average speed associated with the first traffic data (e.g., an average speed of the vehicles traveling along the upstream road segment of the road segment during the interval of time), a second average speed associated with the second traffic data (e.g., an average speed of the vehicles traveling along the first downstream road segment of the road segment during the interval of time), and a third average speed associated with the third traffic data (e.g., an average speed of the vehicles traveling along the second downstream road segment of the road segment during the interval of time).

In certain embodiments, the apparatus 102, such as the processing circuitry 106, can be configured to partition the distribution of speeds associated with the upstream road segment and the first downstream road segment into respective speed clusters to facilitate determining the first average speed associated with the first traffic data and the second average speed associated with the second traffic data. For example, the apparatus 102, such as the processing circuitry 106, can be configured to partition the distribution of speeds associated with the upstream road segment and the first downstream road segment into respective speed clusters to facilitate determining a traffic classification profile related to the highway.

Additionally, in certain embodiments, the apparatus 102, such as the processing circuitry 106, can be configured to partition the distribution of speeds associated with the second downstream road segment into respective speed clusters to facilitate determining the third average speed associated with the third traffic data. For example, the apparatus 102, such as the processing circuitry 106, can be configured to partition the distribution of speeds associated with the second downstream road segment into respective speed clusters to facilitate determining a traffic classification profile related to the ramp. In an embodiment, the apparatus 102, such as the processing circuitry 106, can be configured to determine an average speed for respective speed clusters (e.g., respective speed data clusters). For example, the apparatus 102, such as the processing circuitry 106, can be configured to determine a first average speed for vehicles speeds stored in a first speed cluster, a second average speed for vehicles speeds stored in a second speed cluster, a third average speed for vehicles speeds stored in a third speed cluster, etc.

Additionally or alternatively, in an embodiment, the apparatus 102, such as the processing circuitry 106, can be configured to determine the traffic classification profile for the road segment based on a number of vehicles associated with the first traffic data, the second traffic data and/or the third traffic data. For instance, the apparatus 102, such as the processing circuitry 106, can be configured to determine the traffic classification profile based on a first number of vehicles associated with the first traffic data (e.g., a total number of the vehicles traveling along the upstream road segment of the road segment during the interval of time), a second number of vehicles associated with the second traffic data (e.g., a total number of the vehicles traveling along the first downstream road segment of the road segment during the interval of time), and a third number of vehicles associated with the third traffic data (e.g., a total number of the vehicles traveling along the second downstream road segment of the road segment during the interval of time).

Additionally or alternatively, in an embodiment, the apparatus 102, such as the processing circuitry 106, can be configured to determine the traffic classification profile for the road segment based on a distance interval associated with the first traffic data, the second traffic data and/or the third traffic data. For instance, the apparatus 102, such as the processing circuitry 106, can be configured to determine the traffic classification profile based on a first distance interval associated with the upstream road segment (e.g., a first distance associated with a length of the upstream road segment of the road segment), a second distance interval associated with the first downstream road segment (e.g., a second distance associated with a length of the first downstream road segment of the road segment), and a third distance interval associated with the second downstream road segment (e.g., a third distance associated with a length of the second downstream road segment of the road segment).

In an embodiment, a traffic classification profile for the road segment can classify a traffic even associated with the road segment. For example, the apparatus 102, such as the processing circuitry 106, can be configured to classify the road segment as a ramp congested event in response to a determination that a first average speed associated with the third traffic data is less than a second average speed associated with the first traffic data and the second traffic data. In another example, the apparatus 102, such as the processing circuitry 106, can be configured to classify the road segment as a highway congested event in response to a determination that a first average speed associated with the third traffic data is greater than a second average speed associated with the first traffic data and the second traffic data.

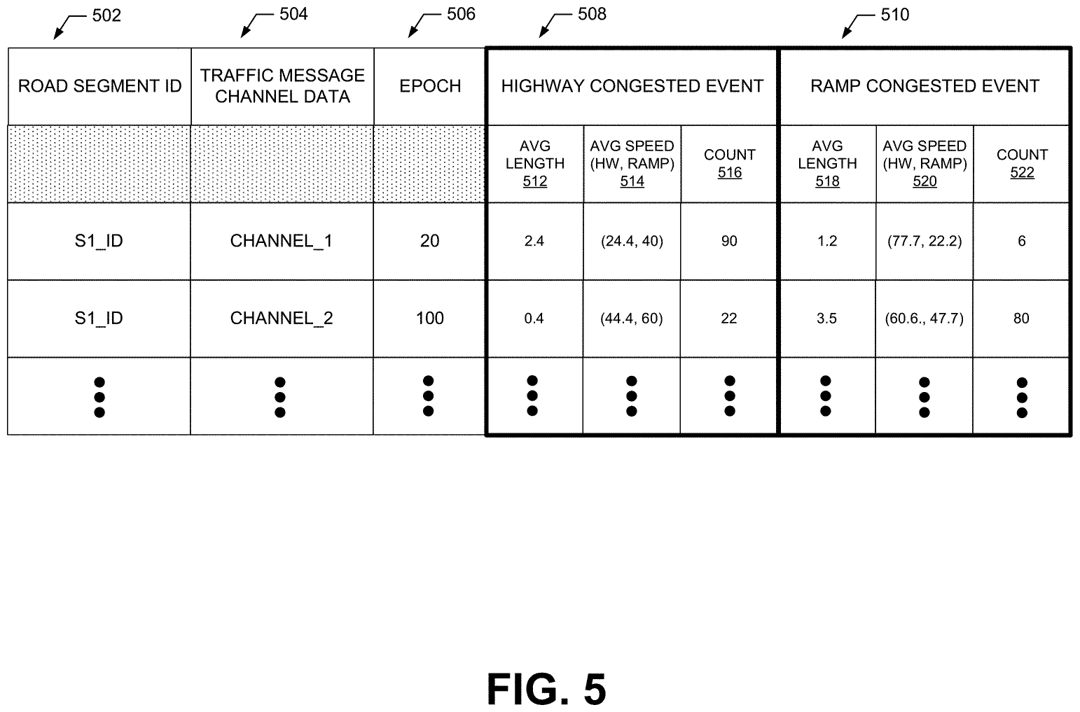

An example of a traffic classification profile data for the road segment is depicted in FIG. 5. For example, the traffic classification profile data can include a road segment ID 502, traffic message channel data 504, epoch 506, a highway congested event 508 and a ramp congested event 510. The highway congestion event 508 can correspond to a vehicle traffic condition where a highway is more congested than a ramp. The ramp congestion event 510 can correspond to a vehicle traffic condition where a ramp is more congested than a highway. A highway can, for example, correspond to the upstream road segment S1 and the first downstream road segment S2. The ramp can, for example, correspond to the second downstream road segment S3.

The road segment ID 502 can include an identification for a portion of the road segment that is associated with the location probe points. For example, the road segment ID 502 can include an identification for the upstream road segment (e.g., S1_ID), an identification for the first downstream road segment (e.g., S2_ID), and/or an identification for the second downstream road segment (e.g., S3_ID). The traffic message data 504 can include information for a traffic message associated with the location probe points. The epoch 506 can include an epoch for the interval of time associated with capture of the location probe points. The highway congested event 508 can be associated with an average length 512, an average speed 514, and/or a count 516. For example, the average length 512 associated with the highway congestion event 508 can include data for an average length of traffic jam associated with a highway. The averages speed 514 can include an average speed for a highway as compared to an average speed of a ramp. The count 516 can include a total number of vehicles that traveled the road segment associated with the road segment 502 during the epoch identified by the epoch 506. Furthermore, the highway congested event 510 can be associated with an average length 518, an average speed 520, and/or a count 522. For example, the average length 518 associated with the ramp congestion event 5010 can include data for an average length of traffic jam associated with a ramp. The averages speed 520 can include an average speed for a highway as compared to an average speed of a ramp. The count 5522 can include a total number of vehicles that traveled the road segment associated with the road segment 502 during the epoch identified by the epoch 506.

The highway congested event 508 can occur with respect to the road segment 300 in response to a determination that an average speed of vehicles traveling along a highway (e.g., the upstream road segment S1 and the first downstream road segment S2) during a particular interval of time is less than an average speed of vehicles traveling along a ramp (e.g., the second downstream road segment S2) during the particular interval of time. In an example, the highway congested event 508 can occur with respect to the road segment 300 in response to a determination (e.g., based on the average speed 514) that an average speed of vehicles traveling along a highway (e.g., the upstream road segment S1 and the first downstream road segment S2) during a particular interval of time (e.g., based on the epoch 506) is 24.4 mph and an average speed of vehicles traveling along a ramp (e.g., the second downstream road segment S3) during the particular interval of time (e.g., based on the epoch 506) is 40 mph. In another example, the highway congested event 508 can occur with respect to the road segment 300 in response to a determination (e.g., based on the average speed 514) that an average speed of vehicles traveling along a highway (e.g., the upstream road segment S1 and the first downstream road segment S2) during a particular interval of time (e.g., based on the epoch 506) is 44.4 mph and an average speed of vehicles traveling along a ramp (e.g., the second downstream road segment S3) during the particular interval of time (e.g., based on the epoch 506) is 60 mph.

The road congested event 510 can occur with respect to the road segment 300 in response to a determination that an average speed of vehicles traveling along a ramp (e.g., the upstream road segment S1 and the first downstream road segment S2) during a particular interval of time is less than an average speed of vehicles traveling along a highway (e.g., the upstream road segment S1 and the first downstream road segment S2) during the particular interval of time. In an example, the road congested event 510 can occur with respect to the road segment 300 in response to a determination (e.g., based on the average speed 520) that an average speed of vehicles traveling along a ramp (e.g., the second downstream road segment S3) during a particular interval of time (e.g., based on the epoch 506) is 22.2 mph and an average speed of vehicles traveling along a highway (e.g., the upstream road segment S1 and the first downstream road segment S2) during the particular interval of time (e.g., based on the epoch 506) is 77.7 mph. In another example, the road congested event 510 can occur with respect to the road segment 300 in response to a determination (e.g., based on the average speed 520) that an average speed of vehicles traveling along a ramp (e.g., the second downstream road segment S3) during a particular interval of time (e.g., based on the epoch 506) is 47.7 mph and an average speed of vehicles traveling along a highway (e.g., the upstream road segment S1 and the first downstream road segment S2) during the particular interval of time (e.g., based on the epoch 506) is 60.6 mph.

In certain embodiments, the apparatus 102, such as the processing circuitry 106, can be configured to determine a distribution of speeds associated with location probe points representative of travel along the road segment during the interval of time. Although the distribution of speeds along the road segment (e.g., the upstream road segment, the first downstream road segment and/or the second downstream road segment) may be represented in various manners, an example distribution of the speeds along the road segment represents speed for each of the vehicles traveling along the road segment during the interval of time. In an embodiment, the apparatus 102, such as the processing circuitry 106, can also be configured to evaluate the distribution of the speeds so as to cluster the speeds associated with the location probe points into a higher speed cluster associated with a higher speed and/or a lower speed cluster associated with lower speed.

Although evaluation of the distribution of the speeds maybe performed in various manners, the apparatus 102, such as the processing circuitry 106, in an example embodiment can be configured to evaluate the distribution of speeds in order to identify if a majority of the location probe points are associated with speeds that fall within two different ranges of speeds (e.g., one range representative of a higher speed cluster and another range representative of a lower speed cluster). These two ranges may be defined in various manners, but, in one embodiment, the higher speed cluster may be separated from a lower speed cluster by at least a predefined amount (e.g., such as 15 mph) or a predefined percentage (e.g., 40%) of an overall range of speeds. In a non-limiting example, a higher speed cluster may be identified within a range of 65-100 mph and another range may be identified from 0-65 mph.

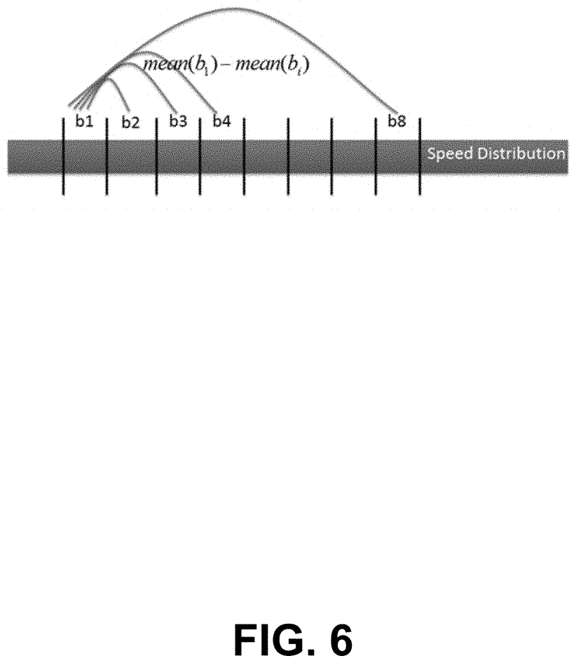

In another embodiment, the apparatus 102, such as the processing circuitry 106, can be configured to determine whether a bi-modality condition exists between the upstream road segment and the downstream road segments (e.g., the first downstream road segment and the second downstream road segment) based upon a relationship between the higher speed and the lower speed during the interval of time. The bi-modality condition may be determined in various manners by the apparatus 102, such as the processing circuitry 106. In an example embodiment, however, the apparatus 102, such as the processing circuitry 106, can be configured to utilizes a clustering algorithm and/or a partitioning algorithm to split a bi-modal speed distribution of the interval of time into the higher speed cluster and the lower speed cluster. In this example embodiment, the apparatus 102, such as the processing circuitry 106, can be configured to separate the speeds associated with the probe points into a plurality of bins designated b1, b2 . . . b8 in the example of FIG. 6 and to then determine the mean distance between the bins, such as represented by mean (b1)-mean (bi).

The apparatus 102, such as the processing circuitry 106, can be further configured to utilize the mean distance between bins to identify the higher speed cluster and the lower speed cluster of the speeds associated with the location probe points. In certain embodiments, the apparatus 102, such as the processing circuitry 106, can be configured to determine a bi-modality value BiM which, in turn, is utilized to identify a bi-modality condition for the interval of time. Although the bi-modality value may be defined in various instances, the apparatus 102, such as the processing circuitry 106, of an example embodiment can be configured to determine the bi-modality value based upon a difference between the mean speeds of the different bins and also based on the range of speeds of the location probe points for the first epoch. In this regard, the bi-modality value may be based upon a ratio of the difference between mean speeds of the different bins and the range of the speeds during the interval of time. By way of example, the bi-modality value may be defined as the greatest difference between the mean speeds of different bins divided by the range of speeds of the location probe points for the first epoch, such as BiM=(mean b1−mean(V-b1))/R with V and R as defined hereinafter.

In an instance in which the bi-modality value fails to satisfy a predefined threshold, such as by being zero or at least less than a predefined threshold, the apparatus 102, such as the processing circuitry 106, can be configured to determine that the distribution of the speeds associated with the location probe points does not indicate a bi-modality condition, such as an instance in which traffic moves along each lane of the road segment upstream of the downstream road segments (e.g., the first downstream road segment and the second downstream road segment) in a relatively uniform manner. However, in an instance in which the bi-modality value satisfies the predefined threshold, such as by exceeding the predefined threshold, a bi-modality condition may be identified for the first epoch.

In an example embodiment, the apparatus 102, such as the processing circuitry 106, can be configured to determine the bi-modality value and to identify a bi-modality condition therefrom in accordance with the following pseudo code:

```
V ← {a set of probe speeds in an epoch}
  function BDM(V):
    s ← STD(V)
    m ← mean(V)
    V ← V ∀ V < m + 2s & V > m − 2s / /first outlier filtering
    d ← Range(V)/8
    for i ← 1 to 8  / /bucketizing
      bᵢ ← {V ∀ V < max(V) & V > (max(V) − d)}
      V ← V − bᵢ
    end for
  V ← b₁ + b₂ + . . . + b₈  / /restore V
  for i ← 2 to 8  / /cluster search
      $BiM ← \frac{mean ( {b}_{1} ) - mean ( {b}_{i} )}{Range ( V )} \qquad$
    if |b₁| > 3 and (|V| − |b₁|) > 3 and BiM > 0.4   / /3 & 0.4 are tuning parameters
      then return: {(mean(b₁), mean(V − b₁), BiM}  / /HS, LS & BiM returned
    else b₁ ← b₁ + bᵢ
    endif
  end for
end BDM
```

As shown in the foregoing pseudo code, location probe points associated with speeds that are outliers, such as location probe points associated with speeds that are more than two standard deviations away from the mean, may be filtered or eliminated by the apparatus 102, such as the processing circuitry 106. Thereafter, the remaining speeds associated with the location probe points of the interval of time may be separated into bins b1, b2, . . . b8 and the BiM may be determined by the apparatus 102, such as the processing circuitry 106, based upon the difference between the means of the various bins as normalized fashion based upon the range. In this analysis, the normalized difference between the means of the different bins may be subjected to various predefined conditions, such as |b1|>3 and BiM>0.4, with the predefined conditions defining tuning parameters that may be varied to achieve desired performance. For example, |b1|>2 and BiM>0.2 in an alternative embodiment. In this regard, the tuning parameters may be selected the apparatus 102, such as the processing circuitry 106, so as to return only as single pair of speeds, representative of the higher speed cluster and the lower speed cluster, as well as the magnitude of bi-modality BiM.

Once a bi-modality condition has been identified, the apparatus 102, such as the processing circuitry 106, can be configured to confirm that the bi-modality condition is attributable to traffic congestion as opposed to a single slow moving vehicle. In order to do so, the apparatus 102, such as the processing circuitry 106 can be configured to compare the lower speed to the free flow speed for the downstream road segment that is fed by the congested lane(s) of the upstream road segment. In an instance in which the ratio of the lower speed to the free flow speed for the corresponding downstream road segment is greater than a predefined threshold, the apparatus 102, such as the processing circuitry 106, can be configured to determine that a bi-modality condition does not exist. However, in an instance in which the ratio of the lower speed to the free flow speed for the corresponding downstream road segment is less than a predefined threshold, the bi-modality condition may be confirmed and processing by the apparatus 102, such as the processing circuitry 106, can proceed.

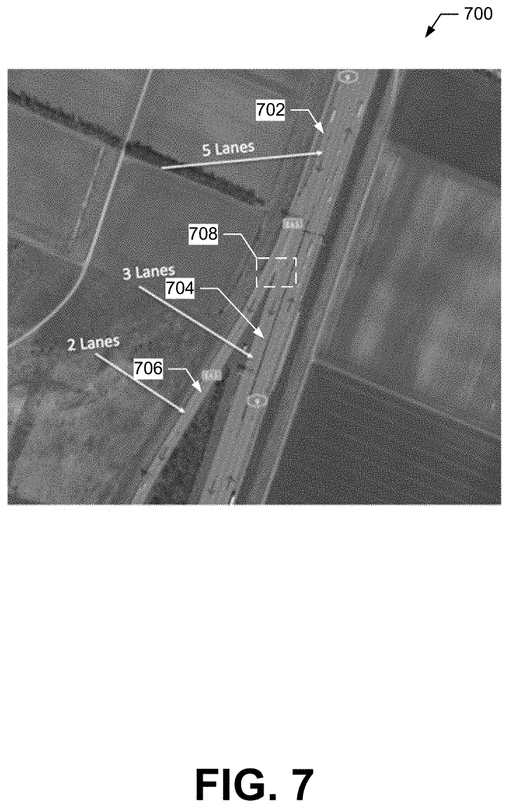

FIG. 7 illustrates a road segment 700 according to an example embodiment of the present disclosure. The road segment 700 can be a multi-lane roadway. As shown in FIG. 7, the road segment 700 includes an upstream road segment 702 that includes 5 lanes for vehicle traffic. In an example, the upstream road segment 702 can be a highway. The road segment 700 also includes a first downstream road segment 704 that includes 3 lanes for vehicle traffic. The first downstream road segment 704 can be, for example, a continuation of the upstream road segment 702 with a decreased number of lanes. For example, the first downstream road segment 704 can also be a highway. Furthermore, the road segment 700 includes a second downstream road segment 704 that includes 2 lanes for vehicle traffic. In an example embodiment, the second downstream road segment 706 can be a ramp (e.g., an exit ramp).

In an embodiment, the apparatus 102, such as the processing circuitry 106, can be configured to determine first traffic data for the upstream road segment 702, second traffic data for the first downstream road segment 704, and/or third traffic data for the second downstream road segment 706. Additionally, the apparatus 102, such as the processing circuitry 106, can be configured to determine whether a split lane traffic event is associated with an intersection 708 between the upstream road segment 702, the first downstream road segment 704, and the second downstream road segment 706. The apparatus 102, such as the processing circuitry 106, can also be configured to determine a traffic classification profile for the road segment 700 based on statistical analysis of the first traffic data for the upstream road segment 702, the second traffic data for the first downstream road segment 704, and/or the third traffic data for the second downstream road segment 706.

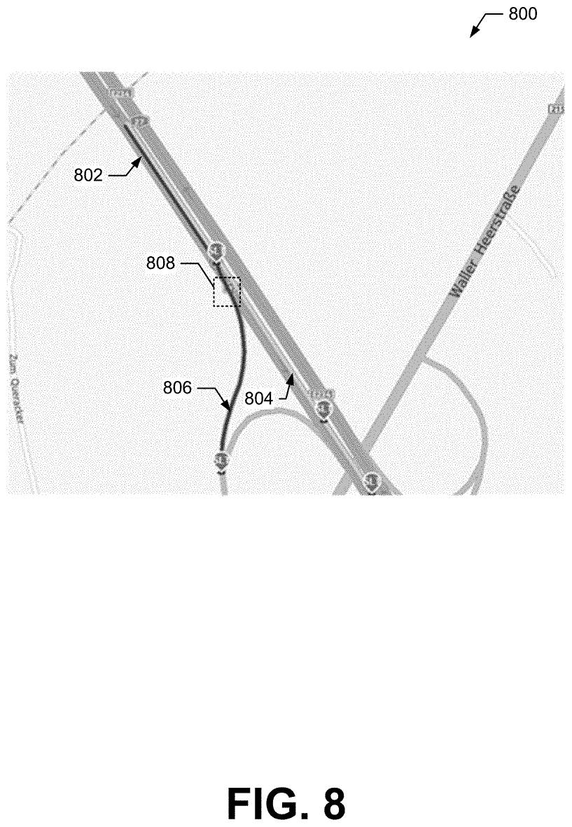

FIG. 8 illustrates a road segment 800 according to an example embodiment of the present disclosure. The road segment 800 can be a multi-lane roadway. As shown in FIG. 8, the road segment 800 includes an upstream road segment 802. In an example, the upstream road segment 802 can be a highway. The road segment 800 also includes a first downstream road segment 804. The first downstream road segment 804 can be, for example, a continuation of the upstream road segment 802. For example, the first downstream road segment 804 can also be a highway. Furthermore, the road segment 800 includes a second downstream road segment 804. In an example embodiment, the second downstream road segment 806 can be a ramp (e.g., an exit ramp).

In an embodiment, the apparatus 102, such as the processing circuitry 106, can be configured to determine first traffic data for the upstream road segment 802, second traffic data for the first downstream road segment 804, and/or third traffic data for the second downstream road segment 806. Additionally, the apparatus 102, such as the processing circuitry 106, can be configured to determine whether a split lane traffic event is associated with an intersection 808 between the upstream road segment 802, the first downstream road segment 804, and the second downstream road segment 706. The apparatus 102, such as the processing circuitry 106, can also be configured to determine a traffic classification profile for the road segment 800 based on statistical analysis of the first traffic data for the upstream road segment 802, the second traffic data for the first downstream road segment 804, and/or the third traffic data for the second downstream road segment 806.

In an embodiment, the apparatus 102, such as the processing circuitry 106, can be configured to determine that the road segment 800 is associated with a ramp congested event in response to a determination that a first average speed associated with the third traffic data is less than a second average speed associated with the first traffic data and the second traffic data. For example, the apparatus 102, such as the processing circuitry 106, can be configured to determine that the road segment 800 is associated with a ramp congested event in response to a determination that traffic associated with the second downstream road segment 806 is slower (e.g., more congested) than traffic associated with the upstream road segment 802 and/or the first downstream road segment 804.

In another embodiment, the apparatus 102, such as the processing circuitry 106, can be configured to determine that the road segment 800 is associated with a highway congested event in response to a determination that a first average speed associated with the third traffic data is greater than a second average speed associated with the first traffic data and the second traffic data. For example, the apparatus 102, such as the processing circuitry 106, can be configured to determine that the road segment 800 is associated with a highway congested event in response to a determination that traffic associated with the second downstream road segment 806 is faster (e.g., less congested) than traffic associated with the upstream road segment 802 and/or the first downstream road segment 804.

In certain embodiments, the apparatus 102, such as the processing circuitry 106, can be configured to facilitate routing of a vehicle based on the traffic classification profile for a road segment. For example, in certain embodiments, the apparatus 102, such as the processing circuitry 106, can be configured to facilitate autonomous driving of a vehicle based on the traffic classification profile for a road segment. Additionally or alternatively, in certain embodiments, the apparatus 102, such as the processing circuitry 106, can be configured to render of data via a map display of a vehicle based on the traffic classification profile for the road segment. Additionally or alternatively, in certain embodiments, the apparatus 102, such as the processing circuitry 106, can be configured to generate split lane congestion data based on the traffic classification profile for the road segment. For example, in certain embodiments, the apparatus 102, such as the processing circuitry 106, can be configured to provide representation of the road geometry of the road segment and/or to generate one or more split lane congestion alert messages to an in-vehicle GPS, in-vehicle navigation system, a PND a portable navigation device or the like.

With respect to the alerting functionality, the apparatus 102, such as the processing circuitry 106 and/or the communication interface 110, can be configured to generate a split lane congestion alert message that is provided to a user device (e.g., a navigation display for a vehicle, a mobile device, a smartphone, a tablet computer, a wearable device, a virtual reality device or another portable computing device). The split lane congestion alert message may also be stored, such as in memory 108, in some embodiments. For example, the split lane congestion alert message may be included as part of an incident feed that also includes messages indicative of roadway accidents, construction, etc. The split lane congestion alert message may be associated with a predefined event code. The split lane congestion alert message may identify the lanes of the upstream road segment that are progressing at the lower speed, such as by either indicating the particular lanes, e.g., the two left lanes, or by more generally indicating that the sluggishness in traffic flow is “on the left” or alternatively “on the right”. The split lane congestion alert message may also optionally indicate the lower speed at which the traffic in the congested lanes is traveling.

Various protocols have been defined for broadcasting traffic messages. In order to provide a split lane congestion alert message, a new message may be defined or an existing message may be modified to include a new or repurposed field to convey information regarding the split lane congestion. By way of example, the Traffic Message Channel (TMC) is one protocol for broadcasting traffic messages. In order to convey information regarding split lane congestion, a new Lane (LN) attribute may be introduced by the TMC protocol within a Sub Segment (SS) attribute. The LN attribute may provide information regarding specific lanes along a roadway. The LN attribute may numerically reference the respective lanes as 1, 2, . . . from the leftmost lane to the rightmost lane. The LN attribute may provide information, such as speed and/or jam factor, for one or more of the respective lanes. The speed is the average speed that current traffic is traveling within the respective lane of the road, while the jam factor of the respective lane is a number, such as between 0.0 and 10.0, calculated based upon the speed within the lane and the jam factor of the road and indicative of the expected quality of travel with lower numbers indicative of a better quality of travel. Thus, a road closure will cause a jam factor of 10.0. Thus, split lane congestion may be identified from the LN attributes in an instance in which the speed and/or jam factors vary significantly between the different lanes of the same road subsegment.

In response to receipt of a split lane congestion alert message, the user device may be configured to alert a user. For example, a map of the split lane traffic location may be displayed with a split lane event message superimposed thereon. In an embodiment, the display not only provides an indication of the lanes that are progressing at the higher speed and the lower speed, but also give advice to a driver to avoid the lanes that are traveling at the lower speed in an instance in which the route of the vehicle can proceed along the lanes of the roadway that are moving at the higher speed. With respect to the foregoing examples, the user device may be configured to identify the split lane congestion alert message in accordance with the protocol with which the traffic messages are broadcast and to correspondingly generate the display based upon the lane level information. In addition to identifying the split lane congestion, the user device may also configured to generate the display so as to illustrate the specific lanes that are experiencing congestion based upon the information provided by the traffic messages.

In addition or alternatively, the user device may provide the split lane event message in other manners, such as via a text message or an audible alert message. In an example embodiment in which a traffic camera is positioned so as to capture the split lane traffic location, the apparatus 102, such as the processing circuitry 106 and/or the communication interface 110, may be configured to provide the user device with an image or a video, such as a real time feed, from the traffic camera such that the user device may provide a display of the image or video from the traffic camera in order to further inform the user. Regardless of the manner in which the split lane event message is presented, the driver of the vehicle may be more fully informed of the split lane traffic incident and, as such, may respond accordingly in order to avoid being inadvertently delayed by the congestion.

In certain embodiments, the apparatus 102 can support a mapping or navigation application so as to present maps or otherwise provide navigation or driver assistance, such as in an example embodiment in which map data is created or updated using methods described herein. For example, the apparatus 102 can provide for display of a map and/or instructions for following a route within a network of roads via a user interface (e.g., a graphical user interface). In order to support a mapping application, the apparatus 102 can include or otherwise be in communication with a geographic database and/or a map database. For example, the geographic database can include node data records, road segment or link data records, point of interest (POI) data records, and other data records. More, fewer or different data records can be provided.

In one embodiment, the data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology can be used, such as electronic horizon sensors, radar, LiDAR, ultrasonic sensors and/or infrared sensors.

In example embodiments, a navigation system user interface can be provided to provide driver assistance to a user traveling along a network of roadways where location probe points collected from vehicles can aid in navigation for other vehicles. Optionally, embodiments described herein can provide assistance for autonomous or semi-autonomous vehicle control. Autonomous vehicle control can include driverless vehicle capability where all vehicle functions are provided by software and hardware to safely drive the vehicle along a path identified by the vehicle. Semi-autonomous vehicle control can be any level of driver assistance from adaptive cruise control, to lane-keep assist, or the like. Establishing vehicle location and position along a road segment can provide information useful to navigation and autonomous or semi-autonomous vehicle control by establishing an accurate and highly specific position of the vehicle on a road segment and even within a lane of the road segment such that map features in the map, e.g., an HD map, associated with the specific position of the vehicle can be reliably used to aid in guidance and vehicle control.

A map service provider database can be used to provide driver assistance, such as via a navigation system and/or through an ADAS having autonomous or semi-autonomous vehicle control features. In one embodiment, a user device can include an ADAS which can include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, a server and/or other device that can perform navigation-related functions, such as digital routing and map display. An end user can use the user device for navigation and map functions such as guidance and map display, for example, and for determination of useful driver assistance information, according to some example embodiments.

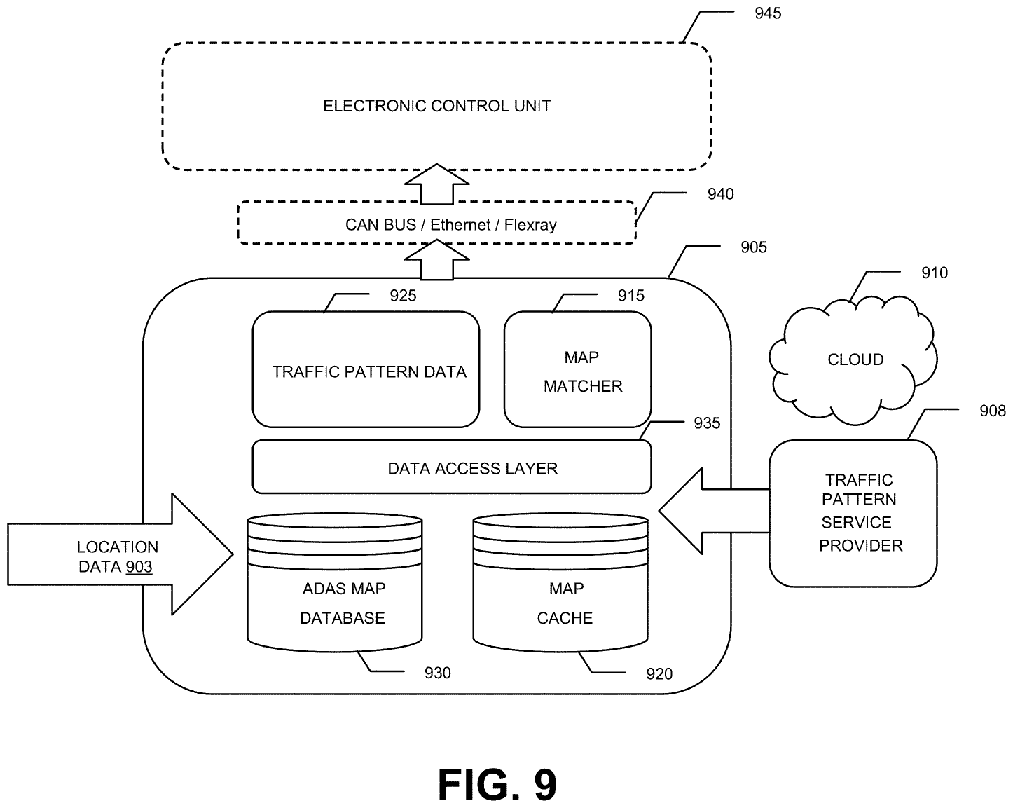

As illustrated in FIG. 9, an architecture includes a traffic pattern service provider 908 that provides traffic pattern data 925 (e.g., a traffic classification profile) to an Advanced Driver Assistance System (ADAS) 905, which may be vehicle-based or server based depending upon the application. The traffic pattern service provider 408 may be a cloud-based 910 service. The ADAS 905 receives location data 903 (e.g., location probe points, navigation information and/or vehicle position) and may provide the location data 903 to map matcher 915. The map matcher 915 may correlate the vehicle position to a road link on a map of the mapped network of roads stored in the map cache 920. This link or segment, along with the direction of travel, may be used to facilitate navigation applicable to the vehicle associated with the ADAS 905, including sensor capability information, autonomous functionality information, etc. The traffic pattern data 925 associated with the road segment specific to the vehicle are provided to the vehicle control, such as via the CAN (computer area network) BUS (or Ethernet or Flexray) 940 to the electronic control unit (ECU) 945 of the vehicle to implement HD map policies, such as various forms of autonomous or assisted driving, or navigation assistance. In certain embodiments, a data access layer 935 can manage and/or facilitate access to the map cache 920, the traffic pattern data 925, and/or a map database 930.

By generating split lane traffic patterns in accordance with one or more example embodiments of the present disclosure, precision and/or confidence of traffic pattern prediction for vehicles can be improved. Furthermore, by generating split lane traffic patterns in accordance with one or more example embodiments of the present disclosure, improved navigation of a vehicle can be provided, improved route guidance for a vehicle can be provided, improved semi-autonomous vehicle control can be provided, and/or improved fully autonomous vehicle control can be provided. Moreover, in accordance with one or more example embodiments of the present disclosure, efficiency of an apparatus including the processing circuitry can be improved and/or the number of computing resources employed by processing circuitry can be reduced.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed:

1. A computer-implemented method for determining a split lane traffic pattern for a road segment, the computer-implemented method comprising:
aggregating, based on a distribution of speeds associated with location probe points representative of travel of vehicles along the road segment during an interval of time, first traffic data for an upstream road segment of the road segment;
aggregating, based on the distribution of speeds associated with the location probe points for the vehicles, second traffic data for a first downstream road segment of the road segment;
aggregating, based on the distribution of speeds associated with the location probe points for the vehicles, third traffic data for a second downstream road segment of the road segment; and
determining a traffic classification profile for the road segment based on statistical analysis of the first traffic data, the second traffic data and the third traffic data.

2. The computer-implemented method of claim 1, wherein the determining the traffic classification profile comprises determining the traffic classification profile based on a first average speed associated with the first traffic data, a second average speed associated with the second traffic data, and a third average speed associated with the third traffic data.

3. The computer-implemented method of claim 2, further comprising:
partitioning the distribution of speeds associated with the upstream road segment and the first downstream road segment into respective speed clusters to facilitate determining the first average speed associated with the first traffic data and the second average speed associated with the second traffic data.

4. The computer-implemented method of claim 2, further comprising:
partitioning the distribution of speeds associated with the second downstream road segment into respective speed clusters to facilitate determining the third average speed associated with the third traffic data.

5. The computer-implemented method of claim 1, wherein the determining the traffic classification profile comprises determining the traffic classification profile based on a first number of vehicles associated with the first traffic data, a second number of vehicles associated with the second traffic data, and a third number of vehicles associated with the third traffic data.

6. The computer-implemented method of claim 1, wherein the determining the traffic classification profile comprises determining the traffic classification profile based on a first distance interval associated with the upstream road segment, a second distance interval associated with the first downstream road segment, and a third distance interval associated with the second downstream road segment.

7. The computer-implemented method of claim 1, wherein the determining the traffic classification profile comprises classifying the road segment as a ramp congested event in response to a determination that a first average speed associated with the third traffic data is less than a second average speed associated with the first traffic data and the second traffic data.

8. The computer-implemented method of claim 1, wherein the determining the traffic classification profile comprises classifying the road segment as a highway congested event in response to a determination that a first average speed associated with the third traffic data is greater than a second average speed associated with the first traffic data and the second traffic data.

9. The computer-implemented method of claim 1, further comprising:
facilitating routing of a vehicle based on the traffic classification profile for the road segment.

10. The computer-implemented method of claim 1, further comprising:
causing rendering of data via a map display based on the traffic classification profile for the road segment.

11. The computer-implemented method of claim 1, further comprising:
generating split lane congestion data based on the traffic classification profile for the road segment.

12. An apparatus configured to determine a split lane traffic pattern for a road segment, the apparatus comprising processing circuitry and at least one memory including computer program code instructions, the computer program code instructions configured to, when executed by the processing circuitry, cause the apparatus to:
aggregate, based on a distribution of speeds associated with location probe points representative of travel of vehicles along the road segment during an interval of time, first traffic data for an upstream road segment of the road segment;
aggregate, based on the distribution of speeds associated with the location probe points for the vehicles, second traffic data for a first downstream road segment of the road segment;
aggregate, based on the distribution of speeds associated with the location probe points for the vehicles, third traffic data for a second downstream road segment of the road segment; and
determine a traffic classification profile for the road segment based on statistical analysis of the first traffic data, the second traffic data and the third traffic data.

13. The apparatus of claim 12, wherein the computer program code instructions are further configured to, when executed by the processing circuitry, cause the apparatus to determine the traffic classification profile based on a first average speed associated with the first traffic data, a second average speed associated with the second traffic data, and a third average speed associated with the third traffic data.

14. The apparatus of claim 12, wherein the computer program code instructions are further configured to, when executed by the processing circuitry, cause the apparatus to determine the traffic classification profile based on a first number of vehicles associated with the first traffic data, a second number of vehicles associated with the second traffic data, and a third number of vehicles associated with the third traffic data.

15. The apparatus of claim 12, wherein the computer program code instructions are further configured to, when executed by the processing circuitry, cause the apparatus to determine the traffic classification profile based on a first distance interval associated with the upstream road segment, a second distance interval associated with the first downstream road segment, and a third distance interval associated with the second downstream road segment.

16. The apparatus of claim 12, wherein the computer program code instructions are further configured to, when executed by the processing circuitry, cause the apparatus to classify the road segment as a ramp congested event in response to a determination that a first average speed associated with the third traffic data is less than a second average speed associated with the first traffic data and the second traffic data.

17. The apparatus of claim 12, wherein the computer program code instructions are further configured to, when executed by the processing circuitry, cause the apparatus to classify the road segment as a highway congested event in response to a determination that a first average speed associated with the third traffic data is greater than a second average speed associated with the first traffic data and the second traffic data.

18. A computer program product comprising at least one non-transitory computer-readable storage medium having computer-executable program code instructions stored therein, the computer-executable program code instructions comprising program code instructions to:
aggregate, based on a distribution of speeds associated with location probe points representative of travel of vehicles along the road segment during an interval of time, first traffic data for an upstream road segment of the road segment;
aggregate, based on the distribution of speeds associated with the location probe points for the vehicles, second traffic data for a first downstream road segment of the road segment;
aggregate, based on the distribution of speeds associated with the location probe points for the vehicles, third traffic data for a second downstream road segment of the road segment; and
determine a traffic classification profile for the road segment based on statistical analysis of the first traffic data, the second traffic data and the third traffic data.

19. The computer program product of claim 18, further comprising program code instructions to classify the road segment as a ramp congested event in response to a determination that a first average speed associated with the third traffic data is less than a second average speed associated with the first traffic data and the second traffic data.

20. The computer program product of claim 18, further comprising program code instructions to classify the road segment as a highway congested event in response to a determination that a first average speed associated with the third traffic data is greater than a second average speed associated with the first traffic data and the second traffic data.
